(19) United States
(12) Patent Application Publication
(10) Pub. No.: US 2017/0113077 A1
(43) Pub. Date: Apr. 27, 2017

(54) APPLICATION DEVICE FOR A SOLID-FILLED PU FOAM

(71) Applicant: Rathor AG, Appenzell (CH)

(72) Inventor: Rainer Nutzel, Weissbad (CH)

(73) Assignee: Rathor AG, Appenzell (CH)

(21) Appl. No.: 15/308,305

(22) PCT Filed: May 4, 2015
(86) PCT No.: PCT/EP2015/059694

§ 371 Date: Dec. 1, 2016

(30) Foreign Application Priority Data
May 2, 2014 (DE) 10 2014 006 272.4

(51) Int. Cl. A62C 2/00; C08G 18/48; B65D 83/14; C08J 9/00; C08G 18/08; B65D 83/68; C09K 21/14; C08G 18/76

(52) U.S. Cl. CPC A62C 2/00; C09K 21/14; C08G 18/4804; C08G 18/7671; C08J 9/0095; C08G 18/14; C08G 18/0838; B65D 83/682; B65D 83/752; C08J 2207/04; C08G 2101/0083

(57) ABSTRACT

The invention relates to an application device for a two-component spray foam for fire protection purposes comprising a first pressurized can with a component A containing a polyisocyanate and a first propellant gas component, a second pressurized can with a component B, containing at least one flameproofing agent in fine-particle form suspended in a polyol component, and a second propellant gas component, a retaining fixture for the first and second pressurized can, with said fixture being provided with a valve receptacle for each of the pressurize cans, a discharging aid for the spray foam, said discharging aid being connected via hose lines to the valve receptacles for the pressurized cans, and a forced mixer that mixes component A with component B when the discharging aid is activated.

The invention relates to an application device for a two-component solid-filled spray foam which primarily is intended for fire prevention/control purposes.

In the building trade foams are used to seal spaces arising between the structure and parts to be installed such as, for example, windows and doors, such foams are based on polyisocyanates and are expelled with the help of a propellant gas. Aside from sealing, foams of this nature also serve for heat insulation purposes and the fixation of installed components. These foams are usually discharged from pressurized containers which allows for simple and quick handling.

Fire prevention/control elements on polyurethane basis have been in use for many years for preventive fire protection measures. Such elements often consist of form pieces made of a special polyurethane foam material which in case of fire expands and carbonizes when exposed to temperatures of more than 150 to 300° C. The foaming process that takes place under carbonization causes a considerable foaming pressure which is sufficient to fill out hollow spaces and, as the case may be, firmly enclose and probably even compress flexible elements exposed to said pressure. The pressure exerted in this case may easily squeeze off plastic pipes used for example for gas or water service.

With the objective of bringing about or enhancing fire retardant properties substances are frequently admixed to expanding foams discharged from pressurized cans. Organic phosphates are usually employed for this purpose, However, to achieve effective fire protection results these materials are insufficient as a rule.

In the interest of attaining an effective fire protection greater amounts of fire resistant materials have to be added to the foams. Such fire proofing materials are usually of mineral origin. However, in the form of a one-component mixture their shelf life/storage stability is inadequate to render them useful for practical purposes. Moreover, the pressurized can contents tends to settle to the bottom or gelatinize.

Fire prevention compounds to be applied by foaming are also offered in the form of so-called cartridge foams, both of one- or two-component type. A one-component cartridge foam based on polyisocyanates and gypsum hydrate is known and has been described, for example, in WO 93/08142 A1. Since the polyisocyanate component reacts with the hydration water of gypsum an acceptable shelf life/storage stability could not be attained.

For this reason cartridge systems were developed that provided for the components to be stored separately and discharged together. In practice, systems of this type have proven to be too inhomogeneous and difficult to discharge. One reason for this is the different viscosity of the two components since the polyisocyanate component usually has a relatively low viscosity while the polyol component containing the mineral additives is highly viscous. Furthermore, the mineral additives tend to settle to the bottom over time and cannot be stirred up or made homogeneous again in the cartridge. Said differences in viscosity cannot be fully compensated when the foam is dispensed mechanically so that an in-homogeneous mixture is created with an increase in viscosity towards the end of the discharging process and, as far as quality is concerned, an inhomogeneous foam being produced. The viscosity increase towards the end of the discharging process often results in the cartridges not being emptied completely. Moreover, foam dosing problems are encountered and the joints and gaps cannot be filled correctly due to the relatively slow foaming process.

When fire protection elements are put to use in new constructed buildings their functionally adequate installation is ensured as a rule. Problems are always encountered if elements for preventive fire protection needs must be subsequently integrated into existing structures—be it to satisfy the requirements imposed by preventive fire protection legislation or take steps to ensure preventive fire protection when carrying out subsequent modification and installation work. Especially the craftsman who is installing pipework or cabling often lacks both the material and the knowledge required to mount such fire protection elements in accordance with good professional practice. Frequently, the unavailability of form pieces is another undesirable hindrance. Particularly in the event of subsequent installations incomplete fire protection measures are taken that lead to openings in masonry and walls, cable passages that are not sealed off and other occurrences conducive to smoke gas propagation and fire spreading.

For that reason, an application system for preventive fire protection is needed that does not have the disadvantages of prior art systems and thus can easily and quickly be employed by craftsmen with a view to expertly sealing off joints, gaps and openings in masonry and walls.

As proposed by the present invention such an easily handled system is provided based on pressurized cans. Accordingly, the invention relates to an application device for a two-component spray foam for fire protection purposes including

a first pressurized can with a component A containing a polyisocyanate and a first propellant gas component,

a second pressurized can with a component B, containing at least one flame-proofing agent in fine-particle form suspended in a polyol component, and a second propellant gas component,

a retaining fixture for the first and second pressurized can, with said fixture being provided with a valve receptacle for each of the pressurize cans,

an activatable discharging aid for the spray foam, said discharging aid being connected via hose lines to the valve receptacles for the pressurized cans, and

a forced mixer that mixes component A with component B when the discharging aid is activated.

The device proposed by the invention can be operated by the craftsman with one hand. This is of advantage because the other hand is not needed for device operation and may be used to provide assistance. The components contained in the two pressurized cans are each stable and have long-time storage capability. Component mixing only takes place upon application which precludes premature reactions.

The system the invention proposes is based on three different and interacting components. Firstly, there are the two pressurized cans containing the basic constituents needed to produce the foam, secondly, there is the retaining fixture which accommodates the pressurized cans, and thirdly, the discharging aid by means of which the contents of the cans are blended with each other and dispensed.

In the first pressurized can there is component A which contains a polyisocyanate and a first propellant gas component. The polyisocyanate is a customary polyisocyanate, i.e. it may be a monomeric polyisocyanate or a prepolymer. Preferred polyisocyanates are those that are based on MDI (4,4′ diphenylmethane diisocyanate, its isomers and higher homologs with higher functionality) as well as their mixtures and prepolymers. Especially crude MDI is also suitable. Other polyisocyanates, for example HDI (hexamethylene diisocyanate) or TDI (toluene-2,4-diisocyanate) may of course also be used, likewise prepolymers based on them.

As first propellant for this component A customary propellant gases may be employed, in particular propane, butane, and dimethyl ether as well as blends thereof. Butane in the form of all its isomers may be used as well as mixtures thereof. Preferred is dimethyl ether mixed with butane, in particular isobutane. Moreover, suitable for use as propellant gas are also HFO propellants (unsaturated fluorinated propellant gases having a low GWP). These are, in particular, the tetrafluoropropenes HFKW 1234yf and 1234ze.

The second pressurized can contains a component B with at least one flame-proofing agent in fine-particle form suspended in a polyol component, and a second propellant gas component.

Propane, butane, and dimethyl ether may likewise be used as second propellant gas for component B. Preferred is dimethyl ether mixed with propane.

Especially mineral substances can be employed as flameproofing agents, for example expandable graphite, polyphosphates, zinc borate, hydrated aluminum oxide (aluminum hydroxide), silicates, in particular sheet silicates, clay minerals, for instance bentonite, silicon dioxide, but also melamine. All these constituents may of course be put to use in the form of optional blends or mixtures. The flame retardant constituents should not exceed about 750 μm in size: especially suitable is a grain size ranging between 40 and 750 μm, Not least because of its expansion characteristics graphite is preferred as flameproofing agent. The flame retardant constituents are suspended in a polyol component (polyol blend). Particularly glycols and glycerol as well as polyethers derived from them may be employed. Basic glycols are in particular ethylene glycol, propylene glycol, butylene glycol and the polyetherols derived from them as well as polyester polyols having a mean molecular weight ranging between 350 and 7000, in particular between 800 and 4000. Pure glycols may of course be used as well, Moreover, sugar-based alcohols may also be suitably applied. The component may also contain water in an amount of up to 10%, preferably up to 4% and in particular in an amount of up to 1.5% by weight in relation to component B. When reacting with polyisocyanate water produces CO₂ which promotes the formation of foam.

Aside from solid flameproofing agents the polyol component may as well contain liquid flameproofing agents. Preferred in this respect are phosphate ester commonly employed in PU chemistry, in particular cresyl diphenyl phosphate and tricresyl phosphate. Flameproofing agents in liquid form facilitate the suspension of the mineral agents.

In component B the amount of flame retardant constituents comes to approx. 10 to 70% w/w and preferably ranges between 40 and 60% w/w in relation to the weight of component B.

Catalysts and customary additives may be present in both components A and B. Suitable for use as catalysts for the reaction of polyisocyanates with hydroxy compounds are the amine catalysts commonly applied. Furthermore, the components may contain suspension aids, agents that have an influence on rheology, agents to reduce or increase the viscosity, as well as foam stabilizers (silicone stabilizers) commercially known in PU chemistry.

Basically, component B contains the same propellants as component A. Preferred as second propellant gas in this case is dimethyl ether together with propane, inter alia because of its viscosity-reducing properties and good compatibility with polyol.

Aside from the basic gases dimethyl ether, propane and butane the propellant gas mixtures may additionally contain the FIFO propellants referred to hereinbefore as well as a certain amount of nitrogen, especially as pressure-producing constituent. Nitrogen helps to impress the soluble propellants into the mixture which improves the foam formation and homogeneity of the dispensed foam.

Practice has shown that a minimum and a maximum pressure should expediently be maintained for the individual components. For component A this pressure ranges between 1.3 and 5.0 bar, in particular between 2 and 3 bar. A pressure of approx. 2.5 bar has proven to be very useful.

As regards component B the minimum pressure amounts to 2.5 bar and the is maximum pressure to 8.0 bar. A preferred pressure range in this case is between 4 and 6 bar, in particular 5.0 bar.

Basically, the pressure in component B should be 1.5 to 2.5 times higher than the pressure in component A, and in particular should be twice as high.

The second propellant of component B contains a proportion of propane especially with a view to maintaining the required pressure. Said propane may be replaced altogether or in part by other pressure-producing gases such as for example nitrogen. On the other hand, in component A an isobutane subset may be used which is fully sufficient to generate the required working pressure. If considered necessary, nitrogen or propane may be admixed here as well.

Generally, it is to be noted that the gas composition is primarily governed by the pressure to be adjusted in the respective component.

The proportion of propellant gas in components A and B usually amounts to 2 to 12 percent by weight based on the total weight of the relevant component, with a propellant amount ranging between 2 and 10 percent by weight being preferred for component A and a weight portion of between 4 and 8 percent by weight or component B.

Due to its mineral filling component B has a much higher viscosity of up to 80,000 mPs which is much higher than that of component A which amounts to approx. 200 mPs. This has an impact on the discharging and mixture characteristics. It may, therefore, be useful to additionally admix to component A an agent that makes said component more thixotropic and/or raises its viscosity, possibly using pyrogenic silica (Aerosil) and/or melamine.

As proposed by the invention the pressurized cans containing components A and B are arranged in a retaining fixture comprising a bottom element and a covering element. The bottom and covering elements are expediently connected with the help of a screw spindle by means of which the cans can be pressed parallelly to each other and simultaneously into valve receptacles arranged in the covering element. The valve receptacles open the two valves allowing the contents of the pressurized cans to be discharged. The valve receptacles are of customary type as employed for the discharge of expanding foams from pressurized cans with spray guns.

Attached to the retaining fixture is a discharging aid to which the contents of the pressurized cans are fed via two separate hoses/tubes. The discharging aid itself has a trigger which serves to control the can contents discharge process. The discharging aid brings the two components together and at its end is provided with a forced mixer of customary design that merges the two components thoroughly before they exit. As a result of the isocyanate/polyol reaction taking place during mixing foam is produced, with the foaming process being assisted/improved if thought necessary or expedient by adding water causing CO₂ to develop. Via the forced mixer the blended components are discharged as foam.

For example, the discharging aid may consist of a spraying device, for instance a spray gun of the type described for two components in publication US 2002/0 038 826 A 1. As a simple and cost-efficient solution a normal hose clamp may also be used by means of which the two feed hoses located before the mixing section can be opened or closed off. Such an arrangement is advantageous in that it may be furnished together with the system and serve as a throwaway item. In that case, the mixing section may be used as application tube or connect to such a tube.

Because of the different viscosities of the two components A and B it may be useful to arrange for the valve receptacles of the first and second pressurized can to only allow exactly the required quantity to pass through, and accordingly configure the receptacle design for the particle sizes involved. Suitable valve designs, for example solids valves for the component B, are known. It is also considered expedient to make adjustment arrangements in the discharging aid system with a view to obtaining the desired throughput and/or particles size of the solid flameproofing agents. To achieve this, the bore size in the entry area of the two hoses can be appropriately provided, for example amount to 0.3 to 2.0 mm, in particular up to 1.5 mm for the low-viscous component A and 1.5 to 4 mm for the highly viscous component B. The bore size appropriate for the respective application can be determined by those skilled in the art by performing simple trials to find the relevant viscosity and/or particle size of the components.

As regards the mixing and discharging characteristics of component B it may be useful for steel balls to be arranged in the second pressurized can, by means of which the can contents can be thoroughly mixed again and the solid constituents of the polyol mixture again be stirred up and dispersed properly.

The invention is explained in more detail by way of the following example.

### EXAMPLE

A component A was prepared for the first pressurized can, said component consisted of 350 g Desmodur 44 V 20 L (MDI mixture) and 25 g dimethyl ether isobutane mixture as first propellant gas.

For component B a mixture was prepared of 290 g polyether polyol 1, 150 g polyether polyol 2, 120 g expandable graphite, 180 g tricresyl phosphate, 8 g water, 5 g silicone stabilizer (Niax L 6900), and 5 g catalyst. 373 g of this mixture were blended in the second pressurized can with 25 g of a propane/butane/dimethyl ether mixture.

After mounting in the retaining fixture and tightening the spindle the first and second pressure cans are activated and ready for the discharge of the foam. Upon actuation of the trigger of the discharging aid a grayish foam is produced which hardens and sets after a few minutes and satisfies the legal regulations prescribed for fire protection.

It shall be understood that the polyisocyanate present in the first pressurized can and the hydroxyl group containing constituents in the second pressurized can are appropriately adjusted to one another such that an essentially complete conversion can be brought about. A slight excess of polyisocyanate is to be considered unobjectionable, especially due to the fact that this excess amount can be eliminated by reaction with air humidity. A minor excess amount of polyol is likewise unproblematic because this polyol may remain in the foam.

1. Application device for a solid-filled two-component spray foam for fire protection purposes comprising
a first pressurized can with a component A containing a polyisocyanate and a first propellant gas component,
a second pressurized can with a component B, containing at least one flameproofing agent in fine-particle form suspended in a polyol component, and a second propellant gas component,
a retaining fixture for the first and second pressurized can, with said fixture being provided with a valve receptacle for each of the pressurize cans,
an activatable discharging aid for the spray foam, said discharging aid being connected via hose lines to the valve receptacles for the pressurized cans, and
a forced mixer that mixes component A with component B when the discharging aid is activated.

2. Device according to claim 1, characterized in that component A contains a polyisocyanate or prepolymer on the basis of MDI.

3. Device according to claim 1, characterized in that component A contains a mixture of MDI isomers and MDI homologs with higher functionality.

4. Device according to claim 1, characterized in that component B contains a polyol based on glycols or glycerol or sugar-based alcohols.

5. Device according to claim 1, characterized in that component B contains a polyol mixture consisting of polyether polyols and/or polyester polyols having a mean molecular weight ranging between 350 and 7000, preferably between 800 and 4000.

6. Device according to claim 1. characterized in that component B contains water in an amount of up to 10 percent by weight, preferably of up to 4% by weight.

7. Device according to claim 1, characterized in that component B contains expandable graphite, polyphosphate, zinc borate, aluminum hydroxide, glass powder, slate, quartz sand, silicates and/or melamine in fine-particle form as flameproofing agent.

8. Device according to claim 1, characterized in that component B contains flameproofing agents in an amount of between 10 and 70 percent by weight, preferably between 40 and 60 percent by weight based on component B.

9. Device according to claim 1, characterized in that component B contains a catalyst.

10. Device according to claim 1, characterized in that the propellant gas component of components A and B contains propane, butane and/or dimethyl ether.

11. Device according to claim 10, characterized in that the propellant gas component of component A and/or B for the most part consists of dimethyl ether, with the first propellant mixture still containing isobutane and the second propellant mixture propane.

12. Device according to claim 1, characterized in that the retaining fixture is provided with a clamping aid for pressurized cans.

13. Device according to claim 12, characterized in that the clamping aid is designed as screw spindle by means of which pressure can valves are impressed into receptacles for activation.

14. Device according to claim 1, characterized in that the discharging aid is designed as spraying element or as application tube.

15. Device according to claim 14, characterized in that the discharging aid is provided with a trigger.

16. Device according to claim 1, characterized in that the discharging aid has bores of different widths for the components A and B as required by and suited for the respective viscosities.

17. Device according to claim 16, characterized in that the size of the bores for component A ranges between 0.3 and 2.0 mm and for component B between 1.5 and 4 mm.
